(19) United States
(12) Patent Application Publication
(10) Pub. No.: US 2013/0153088 A1
(43) Pub. Date: Jun. 20, 2013

(54) METHOD FOR PRODUCING A RARE EARTH-BASED MAGNET

(71) Applicant: Vacuumschmelze GmbH & Co. KG, Hanau (DE)

(72) Inventors: Jörg DREIKORN, Langenselbold (DE); Kaan ÜSTÜNER, Hasselroth (DE); Heinz-Dieter ZILG, Hanau (DE)

(73) Assignee: Vacuumschmelze GmbH & Co. KG, Hanau (DE)

(21) Appl. No.: 13/714,665

(22) Filed: Dec. 14, 2012

Related U.S. Application Data
(60) Provisional application No. 61/576,010, filed on Dec. 15, 2011.

(51) Int. Cl. H01F 41/00

(52) U.S. Cl. CPC H01F 41/005
USPC 148/104; 427/127

(57) ABSTRACT

A method for producing a rare earth-based magnet is provided that comprises providing a precursor sintered R₂Fe₁₄B-type magnet where R represents a rare earth element, applying particles comprising a rare earth element R′ to a first surface of the precursor sintered magnet, applying particles of further material to the first surface of the precursor magnet and/or a further surface of the precursor magnet and heat treating the precursor sintered magnet. The heat treating is carried out at a temperature T for a time t selected to allow diffusion of the rare earth element R′ into the precursor sintered magnet to produce a magnet. The further material remains solid and particulate after the heat treating.

This application claims benefit of the filing date of U.S. Provisional Patent Application Ser. No. 61/576,010, filed Dec. 15, 2011, the entire contents of which are incorporated herein by reference for all purposes.

### BACKGROUND

1. Field

This application is directed to methods for producing rare earth magnets.

2. Description of Related Art

Rare earth-based magnets, such as sintered Nd₂Fe₁₄B-type magnets, are used in many applications, for example as a component of a motor of a hybrid car.

It is desirable to increase the coercivity without decreasing the remanence of these rare earth-based magnets. This may be performed by applying a layer of dysprosium and/or terbium to the surface of a sintered Nd₂Fe₁₄B-type magnet and heating it to cause the dysprosium and/or terbium to diffuse along the grain boundaries of the sintered magnet.

This grain boundary diffusion process has the advantage that the coercivity of the Nd₂Fe₁₄B-type magnet is increased and, at the same time, the residual flux density is maintained so that it is compatible to that of a sintered Nd₂Fe₁₄B-type magnet that has not undergone the grain boundary diffusion treatment.

US 2009/0252865 discloses a grain boundary diffusion method for Nd₂Fe₁₄B-type magnets in which the dysprosium and/or terbium is applied in the form of a metal powder to a paraffin coated sintered Nd₂Fe₁₄B-type magnet. A heat treatment is carried out under conditions suitable to cause the dysprosium and/or terbium to diffuse along the grain boundaries resulting in an increased coercivity of the magnet.

This method of applying dysprosium and/or terbium powders to the outside of a sintered Nd₂Fe₁₄B-type magnet has the advantage over the use of vacuum deposition techniques, such as sputtering, to deposit the dysprosium and/or terbium in that it is cheaper to perform and the material loss is lower. As dysprosium and, especially, terbium are expensive, effective use of these elements is desirable.

However, further improvements to methods for producing rare earth-based magnets with a high maximum energy product which can also be performed more cost effectively are desirable.

### SUMMARY

A method for producing a rare earth-based magnet is provided that comprises providing a precursor sintered R₂Fe₁₄B-type magnet where R represents a rare earth element, applying particles comprising a rare earth element R′ to a first surface of the precursor sintered magnet, applying particles of further material to the first surface of the precursor sintered magnet and/or a further surface of the precursor sintered magnet and heat treating the precursor sintered magnet. Heat treating is carried out at a temperature T for a time t selected to allow diffusion of the rare earth element R′ into the precursor sintered magnet to produce a magnet. The further material remains solid and particulate after the heat treating.

Since the further material remains solid and particulate on the surface of the magnet, onto which it was applied, after heat treating, it acts as a separation material. Consequently, precursor sintered magnets comprising particles of the rare earth element R′ can be heat treated when in physical contact with further precursor sintered magnets.

In one embodiment, the further material and the rare earth element R′ are applied to the same surface. The surface comprising the rare earth element R′ and the further material may be in direct contact with a further surface comprising the rare earth element R′ or with a surface comprising the R₂Fe₁₄B composition during the heat treating. Afterwards, the two or more contacting magnets can be easily separated from one another due to the presence of the further material which remains solid and particulate on the surface of the magnet onto which the rare earth element R′ and the further material was applied before the heat treating. Therefore, bonding of contacting magnets to one another due to melting or a formation of a melt comprising the rare earth element R′ is avoided. A packing density of the precursor sintered magnets in a furnace, in which the heat treating is performed, can be increased and production costs can be lowered.

In an alternative embodiment, the particles of the rare earth element R′ and the particles of the further material are applied to different surfaces. During heat treating a plurality of such precursor sintered magnets may be arranged such that the particles of the further material of a first precursor magnet are in contact with the particles of the rare earth element R′ of a second precursor sintered magnet. As the further material remains solid and particulate after heat treating, bonding of the contacting magnets is prevented.

A rare earth element is defined as one of the lanthanide elements of the periodic table and scandium and yttrium.

A R₂Fe₁₄B-type is used to describe the structure of the phase rather than the composition. For example, R may represent two or more rare earth elements included as a mixture in the R₂Fe₁₄B structure. A R₂Fe₁₄B-type magnet may also include further elements such as metallic elements, for example Al, Co, Cu and Ga and additional phases such as rare earth rich phases.

The rare earth element R′ is defined as one or more of these elements which has the ability to diffuse along grain boundaries of a sintered R₂Fe₁₄B-type magnet. The rare earth element R′ is further defined herein as the rare earth element which is applied to the surface of the precursor sintered magnet. In some embodiments, the precursor sintered magnet also comprises the same rare earth element which is applied to the surface of the precursor sintered magnet.

The further material is a material which remains solid and particulate on the surface of a R₂Fe₁₄B-type magnet after heat treating at a temperature T for a time t.

In some embodiments, the particles of the rare earth element R′ may be applied in the form of a continuous layer that completely covers the entire surface to which it is applied. In some embodiments, the particles of the rare earth element R′ may be applied discontinuously to the surface, for example and without limitation, in the form of one or more stripes, one or more discrete points, one or more meandering lines.

The particles of the further material may also be applied in the form of a continuous layer or discontinuously to the surface. The form of the application may correspond to, or may be different from, the form of the application of the rare earth element R′ applied to the same surface of an adjacent surface.

In an embodiment, a plurality of precursor sintered R₂Fe₁₄B-type magnets is provided and the particles comprising the rare earth element R′ and particles of the further material are applied to the first surface of the plurality of precursor sintered magnets. The plurality of precursor sintered magnets are arranged such that particles of the rare earth element R′ are positioned between adjacent precursor sintered magnets such that a surface of a first precursor sintered magnet is in contact with the particles of the rare earth element R′ applied to a second adjacent precursor sintered magnet. The plurality of precursor sintered magnets are heat treated at a temperature T and for a time t selected such that the rare earth element R′ diffuses into the precursor sintered magnets and such that after the heat treating adjacent magnets remain unbonded to one another.

The particles of the rare earth element R′ applied to one precursor sintered magnet are also in contact with a further surface of a second separate precursor sintered magnet. Therefore, the rare earth element R′ is able to diffuse along the grain boundaries of both the first precursor sintered magnet onto which they were first applied as well as along the grain boundaries of the adjacent precursor sintered magnet although they were not applied to this surface, but are in contact with this surface during the heat treating.

The use of the further material which is applied to the same surface as the rare earth element R′ prevents the magnets from bonding to one another and/or to other surfaces, in which the rare earth element R′ is in contact, due to the production of a melt comprising the rare earth element R′. Therefore, the packing density of the precursor sintered magnets during a heat treatment can be high, since the precursor sintered magnets may be in contact with one another.

In an embodiment, the particles of the rare earth element R′ and the particles of the further material are applied to different surfaces for each of a plurality of precursor sintered magnets. For example, the particles of the rare earth element R′ and the particles of the further material may be applied to opposing surfaces. The plurality of precursor sintered magnets may be arranged such that the surface of a first precursor sintered magnet comprising particles of the rare earth element R′ is in contact with the surface of a second of the plurality of precursor sintered magnets which comprises the particles of the further material. Such an arrangement may be used to increase the packing density of the precursor sintered magnets during heat treating whilst at the same time preventing the contacting magnets from bonding to one another. If the plurality of precursor sintered magnets are arranged in a row, the plurality of precursor sintered magnets may be arranged such that the surfaces of each of the precursor sintered magnets comprising the rare earth element R′ face in the same direction and such that the surfaces of each of the precursor sintered magnets comprising the further material face in the opposing direction.

The plurality of precursor sintered magnets may be arranged in a variety of ways such that particles of the rare earth element R′ are positioned between adjacent precursor sintered magnets such that a surface of the first precursor sintered magnet is in contact with the particles of the rare earth element R′ applied to an adjacent second precursor sintered magnet.

For example, the precursor sintered magnets including a surface comprising the rare earth element R′ and the further material may be arranged in regularly, for example in stacks or rows, or irregularly, for example in one or more heaps. Stacks and rows may be more suitable for the heat treatment of larger magnets having opposing parallel surfaces. Heaps may be more suitable for small magnets or magnets having an irregular shape which do not lend themselves to being stacked easily.

In a further embodiment, particles comprising the rare earth element R′ are applied to a second surface of at least one of the precursor sintered magnets. The second surface opposes the first surface. Particles of the further material are also applied to the second surface of the at least one precursor sintered magnet. This embodiment may be used to reduce the diffusion time since the rare earth element R′ has to diffuse only through half of the thickness of the precursor sintered magnet between the first and second surfaces.

In a further embodiment in which the plurality of precursors sintered magnets is arranged in a row, the outermost side surfaces of the endmost precursor sintered magnets of the row comprise particles of the rare earth element R′ and particles of the further material.

For example, one of the two outermost precursor sintered magnets of a row may have a first surface and a second surface comprising the rare earth element R′ and the further material, whereas the rest of the precursor sintered magnets positioned in the row may comprise only a single surface comprising the rare earth element R′ and the further material. The precursor sintered magnets are arranged such that the outermost side surfaces of the endmost precursor sintered magnets of the row comprised particles of the rare earth element R′ and particles of the further material and the further precursor sintered magnets arranged between these endmost precursor sintered magnets are arranged such that layers comprising particles of the rare earth element R′ and particles of the further material alternate with precursor sintered magnets.

This arrangement provides a more homogenous distribution of the rare earth element R′ over the row and therefore allows a homogenous diffusion of the rare earth element R′ throughout the magnets of the row such that the magnetic properties of the magnets of the row, in particular the coercivity, are uniform.

In a further embodiment, three or more surfaces of the precursor sintered magnet or magnets comprise the rare earth element R′ and the further material. All of the surfaces of the precursor sintered magnet or magnets may comprise the rare earth element R′ and the further material so that the outer surfaces of the precursor sintered magnet of magnets may be considered to be completely covered with the rare earth element R′ and the further material. This embodiment may be useful if the precursor rare earth magnets are heat treated in an irregular heap as it cannot be predicted in advance which surfaces of adjacent precursor sintered magnets may be in contact with one another in the heap.

In some embodiments, one or more precursor sintered magnets are in direct physical contact with one another during the heat treating. Depending on the application of the particles of the rare earth element R′ and of the further material, the particles of the rare earth element R′ and/or the particles of the further material and/or an as-sintered surface of the precursor sintered magnet may be in direct physical contact with particles of the rare earth element R′ and/or the particles of the further material and/or an as-sintered surface of a further precursor sintered magnet.

In some embodiments, the rare earth element R′ may diffuse into the precursor sintered magnet or magnets not only by means of a liquid phase, but also by means of a gaseous route. If the rare earth element R′ diffuses into the precursor sintered magnet or magnets by a gaseous route, the rare earth element R′ need not be in direct contact with the magnet into which it diffuses. It may also diffuse into a precursor sintered magnet or magnets that is positioned spaced at a short distance from the rare earth element R′. The rare earth element R′ may move in a gaseous phase across the space between the particles of the rare earth element R′ and the precursor sintered magnet in the gaseous phase and then diffuse into the precursor sintered magnet, possibly along the grain boundaries of the precursor sintered magnet.

In a further embodiment, a substrate is provided onto which the precursor sintered magnets are positioned prior to the heat treating. In this embodiment, particles of the further material placed on the substrate and the precursor sintered magnets are placed on the particles of the further material. The further material therefore acts as a separation means so that the magnets remain unbonded to the substrate and can easily be removed. The substrate may be a floor of a furnace or a further container enclosing the one or more precursor sintered magnets. If the precursor sintered magnet or magnets are wrapped in a foil during heat treatment, the foil surface facing the precursor sintered magnets may be coated with the further material.

In a further embodiment, the rare earth element R′ and the further material are positioned on the substrate. The rare earth element R′, which is positioned on the substrate is able to diffuse along grain boundaries of a precursor sintered mater which is in contact with the substrate. This embodiment may be useful if the precursor sintered magnet or magnets are wrapped in a foil during heat treatment, for example. This arrangement may be used to allow the rare earth element R′ to diffuse into grain boundaries extending to an additional surface of the precursor sintered magnet and improve the homogeneity of the distribution of the rare earth element R′.

The rare earth element or elements R of the precursor sintered magnet may be different from the rare earth element R′. In one embodiment, R′ is dysprosium or terbium. Alternatively, the rare earth element R′ may be a mixture of two or more different rare earth elements. The rare earth element R of the precursor sintered magnet may be a mixture of neodymium and dysprosium. In one particular embodiment, the rare earth element R is a mixture of neodymium and dysprosium and the rare earth element R′ is dysprosium.

The rare earth element R′ may be applied to the first and, optionally, further surfaces of the precursor sintered magnets in the form of a hydride or a hydrogenated alloy or an alloy of the rare earth element R′.

In the following, the amount of the rare earth element R′ is given as a weight percentage of the weight of the precursor sintered magnet.

0.01 wt % to 2 wt %, preferably 0.1 wt % to 0.6 wt %, of the rare earth element R′ may be applied to the first surface of the precursor sintered magnet. In the case of a precursor sintered magnet in which two or more surfaces comprise particles of the rare earth element R′, 0.01 wt % to 2 wt %, preferably 0.1 wt % to 0.6 wt %, of the rare earth element R′ may be applied to each surface or an amount in this range may be divided over two or more surfaces. For example, in the case of two surfaces, each surface comprises 0.005 wt % to 1 wt %, preferably 0.05 wt % to 0.3 wt %, of the rare earth element R′.

In an embodiment, the volume ratio of the rare earth element R′ to the further material is between 20 to 1 and 1 to 10.

The temperature T and the time t of the heat treating are selected to allow diffusion of the rare earth element R′ into the precursor sintered magnet, in particular, to allow diffusion of the rare earth element R′ along the grain boundaries of the precursor sintered magnet. In a further embodiment, the precursor sintered magnet has a coercive field strength H_{C} and the temperature T and the time t are selected such that after the heat treating the magnet has increased coercive field strength that is at least 1 kOe greater than the coercive field strength H_{c} before the heat treating.

The temperature T may be within a range of 700° C. to 1100° C. and the time t may lie within a range of 0.1 hours to 100 hours, preferably, 0.1 hours to 20 hours, preferably 2 hours to 10 hours. The time t may be increased for decreasing temperatures in order to achieve the desired diffusion and increased coercive field strength.

In one embodiment, the further material is an oxide. The further material may be an oxide of a rare earth element R″ where R″ is different from R and R′. In an alternative embodiment, the further material is an oxide of the rare earth element R and, in one particular embodiment, the further material is neodymium oxide.

In one embodiment, the further material is an oxide of a rare earth element R′″, where R′″ is different from R′. As the rare earth element R′ has the ability to diffuse along grain boundaries of a sintered R₂Fe₁₄B-type magnet, the particles comprising the rare earth element R′ melting during the heat treating. Such elements may be unsuitable for use as the further material, since any melting may not enable the further material to remain solid and particulate after the heat treating and to act as a separation material.

R′″ may be one or more of the rare earth elements of the lanthanide elements of the periodic table and/or scandium and/or yttrium but not a rare earth element R′ which is defined as one or more of these elements which has the ability to diffuse along grain boundaries of a sintered R₂Fe₁₄B-type magnet. In one particular embodiment, R′″ may be one or more of the rare earth elements of the lanthanide elements of the periodic table and/or scandium and/or yttrium other than dysprosium and terbium. In other words, dysprosium and terbium are excluded as possible elements for R′″ in this particular embodiment.

The rare earth element R′ and the further material may be applied to an as-sintered surface. In these embodiments, the precursor sintered magnets are not further worked or treated after their fabrication and before the rare earth element R′ and the further material are applied. This has the advantage that the number of processing steps is kept low and the cost effectiveness of the method is increased.

The particles of the rare earth element R′ and the particles of the further material may be intimately mixed with one another and applied to the first surface and, optionally, the second surface of the precursor sintered magnets in the form of a single layer.

Alternatively, they may be applied separately to the same surface as two layers with the rare earth element R′ being applied directly to the surface comprising the R₂Fe₁₄B composition and the particles of the further material, which acts as a separating means, being applied to the layer comprising the rare earth element R′.

In an embodiment, the particles of the rare earth element R′ and/or the particles of the further material are mixed with at least one liquid or organic substance to form a suspension or paste and the suspension or the paste is applied to the first surface and, optionally, the second surface or further surfaces of the precursor sintered magnet. Use of a suspension or paste has the advantage that the application of particulate material to the precursor sintered magnets can be avoided which simplifies handling.

In a further embodiment, before being heat-treated at temperature T, a further drying or debinding treatment is carried out at conditions sufficient to remove organic substances from the precursor sintered magnets. For example, the drying or debinding treatment may be carried out at room temperature under vacuum or at a temperature above room temperature, but less than the temperature T. The additional drying treatment has been found to further reduce the likelihood of precursor sintered magnets, which are in contact with one another during the heat treating, from becoming bonded to one another such that they cannot be easily separated.

In one embodiment, one or more further metals and/or one or more alloys one or more metal hydrides and/or one or more hydrogenated alloys are applied to the first surface and optionally one or more further surfaces. These further materials may be added to the suspension or paste or may be applied directly without the use of a suspension or paste.

These additional materials may be included so as to have different effects. For example, an additional metal and/or alloy may be used to decrease the melting temperature of the rare earth element R′ by forming a eutectic with the rare earth element R′ and thus ease a diffusion of the rare earth element R′ into the precursor sintered magnets and/or lower the temperature of the heat treating which is suitable to allow diffusion of the rare earth element R′ into the precursor sintered magnet.

In one particular embodiment, aluminium, and/or nickel and/or copper or their alloys are applied to the first surface and optionally one or more further surfaces.

The one or more metals and/or one or more alloys may also be added to improve the magnetic and/or the electric properties and/or the corrosion resistance and/or the mechanical properties of the magnet.

Additionally, one or more binders and/or one or more dispersants may be added to form the paste. Binders and/or dispersants are useful to prevent agglomeration of the particles in the suspension or paste and may also be useful in creating a homogenous composition if the suspension and/or paste comprises two or more different materials.

In one particular embodiment, the paste comprises neodymium oxide, fumed silica, and 3-Methoxy-1-butanol (CH₃CH(OCH₃)CH₂CH₂OH).

Fumed silica is silicon dioxide which has been fabricated using a fuming method so as to provide very fine particles. Additionally, fumed silica includes a further functional group such as an organic octyl surface group. Fumed silica may also be hydrophobic. An example of fumed silica is hydrophobic fumed silica with an organic octyl surface group which is commercially available from the company Degussa under the trade name Aerosil® and in particular Aerosil® R805.

The paste for the suspension may be applied by one or more of a variety of methods including painting or screen printing or doctor plating or by gravity or dipping or roller application or spraying or pad printing, for example.

As discussed above, the further material acts as a separating means. After the heat treating magnets are separable from adjacent magnets by applying a predetermined force between the adjacent magnets, for example a force sufficient to separate the magnets without any surface damage or cracking.

After the heat treating, the magnet comprises the rare earth element R′ with a content which has a distribution that varies from the first surface in directions towards a centre of the magnet. The content of the rare earth element R′ is highest at the surface on which it was applied and decreases in directions towards the centre of the magnet. As defined above, the rare earth element R′ denotes the rare earth element which is applied to the surface of the precursor sintered magnet. In embodiments in which the rare earth element comprises two or more different rare earth elements and one of these rare earth elements is the same as that applied to the surface of the precursor sintered magnet, the distribution of the rare earth element R′ relates only to the additional rare earth element R′ which was applied to the surface of the precursor sintered magnet.

The rare earth element R′ may be present in significant amounts in an outermost edge portion of the magnet, for example, within 1.5 mm of the surface onto which they were applied. The rare earth element R′ may be found in grain boundary regions of the precursor sintered magnet and central portions of grains may be largely free or completely free of the rare earth element R′. This structure enables the coercivity H_{c} to be increased whilst maintaining the residual flux density. The rare earth element R′ relates only to the additional rare earth element R′ which was applied to the surface of the precursor sintered magnet.

### BRIEF DESCRIPTION OF DRAWINGS

Embodiments will now be described with reference to the accompanying drawings.

FIG. 1 is a schematic drawing that illustrates a method of applying particles comprising a rare earth element and a separating material.

FIG. 2 is a schematic drawing that illustrates a method of arranging precursor sintered magnets including a layer comprising particles of the rare earth element and the separating material,

FIG. 3 is a schematic drawing that illustrates a method of producing the magnet from the precursor sintered magnet of FIG. 2.

FIG. 4 is a schematic drawing that illustrates a method of heat treating precursor sintered magnets according to a second embodiment.

FIG. 5a is a schematic drawing that illustrates a method of heat treating precursor sintered magnets according to a third embodiment.

FIG. 5b is a schematic drawing that illustrates a method of heat treating precursor sintered magnets according to a fourth embodiment.

FIG. 6 illustrates a graph of coercive field strength at room temperature for magnets as a function of composition of the rare earth element R′.

FIG. 7 illustrates a graph of coercive field strength as a function of the quantity of dysprosium applied.

FIG. 8 illustrates a graph of coercive field strength with and without a separation material.

FIG. 9 illustrates a graph of coercive field strength and dysprosium uptake as a function of temperature for a 6 hour heat treatment.

FIG. 10 illustrates a graph of Dysprosium uptake as a function of depth.

FIG. 11 illustrates a graph of coercive field strength at room temperature for samples coated with a dysprosium alloy and given a grain boundary diffusion treatment under different conditions.

FIG. 12 illustrates a graph of coercive field strength after a grain boundary diffusion treatment for samples with and without surface pre-treatment.

Table 1 illustrates the composition of five pastes.

Table 2 summarises the results of five examples of pastes and Nd₂O₃ contents after a grain boundary diffusion heat treatment.

Table 3 summarises the composition of dysprosium containing alloy paste.

### DETAILED DESCRIPTION OF SPECIFIC EMBODIMENTS

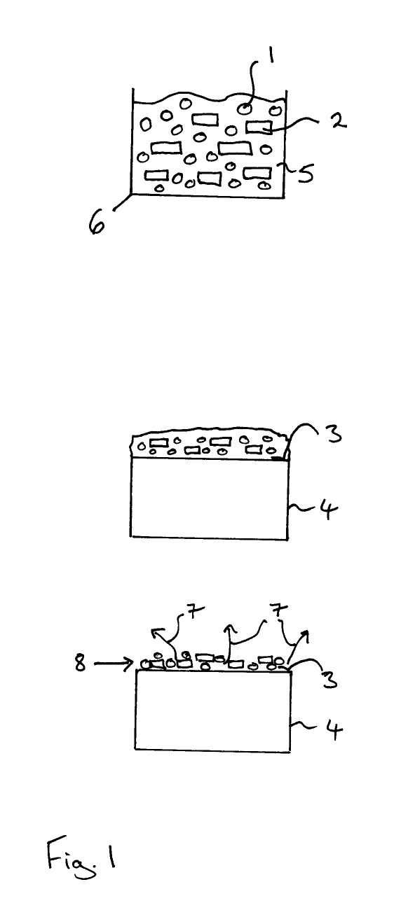

FIG. 1 illustrates a method of applying first particles 1 comprising a rare earth element and second particles 2 comprising a separating material to a first surface 3 of a rare earth-based magnet 4, in particular a precursor sintered R₂Fe₁₄B-type magnet.

In this particular embodiment, R is a mixture of neodymium and dysprosium. The further material of second particles 2 is neodymium oxide and the first particles 1 comprising a rare earth element R′ are dysprosium hydride.

For illustrative purposes, the first particles 1 comprising the rare earth element R′ are illustrated as having a generally circular form and the second particles 2 of the further material are illustrated as having a rectangular form. However, these two forms are merely used to distinguish the two types of particles from one another in the drawings and are not intended to describe the shape of the particles. The first particles 1 of the rare earth element R′ and the second particles 2 of the further material may have any form including the same form and may be of different sizes or of the same size.

The first particles 1 of the rare earth element and the second particles 2 of the further material are mixed with a liquid 5, or organic substance and fumed silica to form a suspension 6. In this particular embodiment 3-Methoxy-1-butanol (CH₃CH(OCH₃)CH₂CH₂OH) is used. The suspension 6 is applied to the first surface 3 of the precursor sintered magnet 4 to form a liquid layer comprising first particles 1 of the rare earth element R′ and second particles 2 of the further material. The liquid 5 or organic substance is then removed by evaporation as is illustrated by arrows 7 in FIG. 1 to leave a layer 8 comprising first particles 1 of the rare earth element R′ and second particles 2 of the further material positioned on the first surface 3 of the precursor sintered magnet 4.

In this embodiment, the first surface 3 is an as sintered surface and has not been further treated, for example pickled.

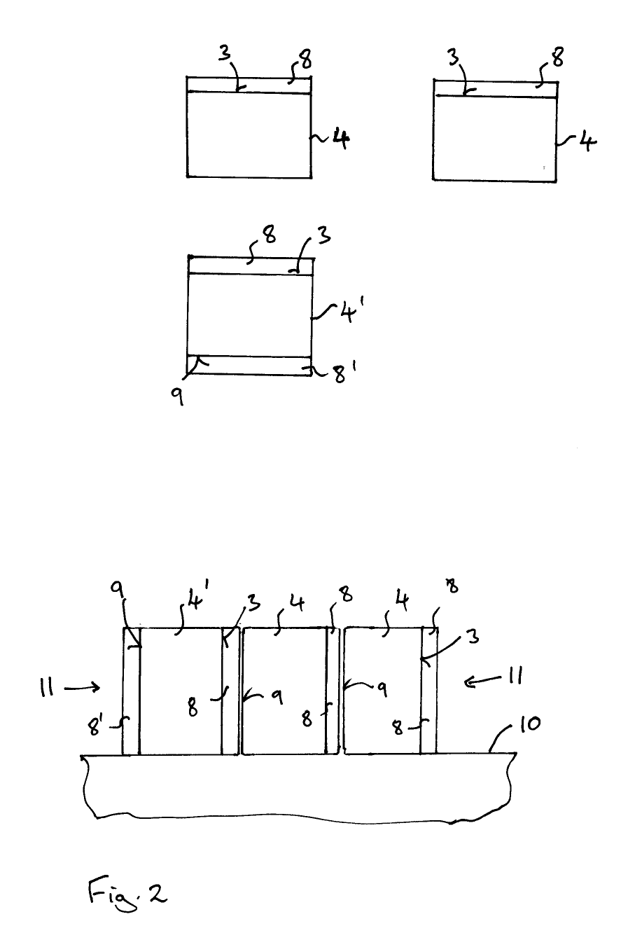

FIG. 2 illustrates a method according to a first embodiment of arranging a plurality of precursor sintered R₂Fe₁₄B-type magnets 4 comprising the layer 8 of first particles of the rare earth element R′ and second particles of a further material. Three precursor sintered magnets are illustrated in FIG. 2. However, four or more precursor sintered magnets can also be arranged in the same way. Two of the precursor sintered magnets 4 comprise a single layer 8 and one of the precursor sintered magnets 4′ comprises a second layer 8′ arranged on a second surface 9 of the precursor sintered magnet 4′. The second surface 9 is arranged on the opposing side of the precursor sintered magnet 4 to the first surface 3.

The three precursor sintered magnets 4 and 4′ are arranged in a row on a substrate 10. The precursor sintered magnets 4, 4′ are arranged such that the outermost end faces 11 of the row comprise the layer 8 or the layer 8′ and each precursor sintered magnet 4, 4′ is arranged alternately with a layer 8 in the row.

In this particular embodiment, the left-hand precursor sintered magnet 4′ includes two layers 8, 8′. The second surface 9 of the adjacent precursor sintered magnet 4 is arranged so that it is in contact with layer 8 of the adjacent precursor sintered magnet 4′. The third precursor sintered magnet 4 is arranged adjacent the second precursor sintered magnet 4 such that the second surface 9 which comprises the R₂Fe₁₄B composition is placed in direct contact with the layer 8 of the adjacent magnet comprising the first particles of the rare earth element R′ and the second particles of the further material.

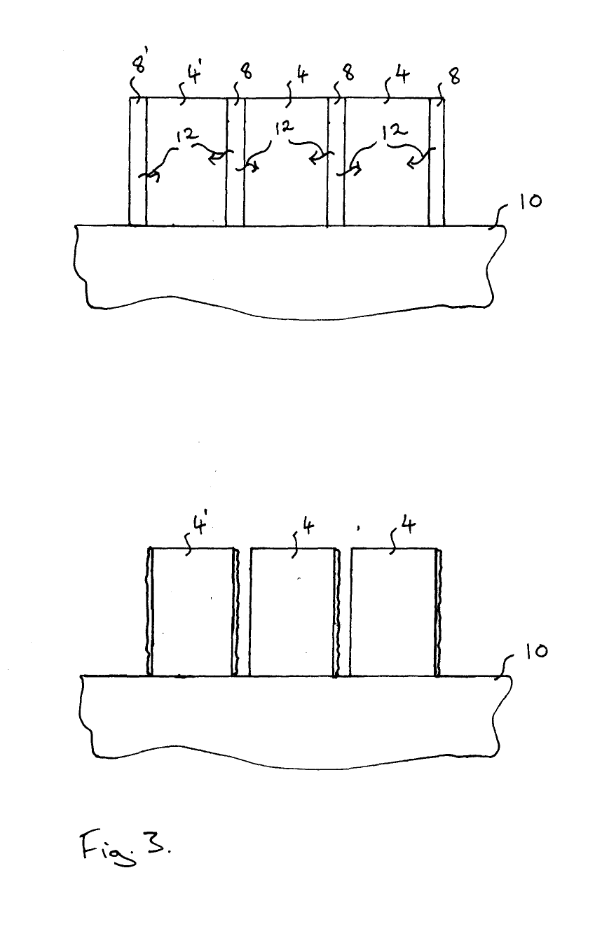

FIG. 3 illustrates the heat treatment of the row of precursor sintered magnets illustrated in FIG. 2. The heat treatment is carried out at a temperature T and for a time t which allows diffusion of the rare earth element R′ from the layer 8, 8′ positioned on the surfaces of the precursor sintered magnet 4, 4′ into the body of the precursor sintered magnet 4, 4′. In particular, the rare earth element R′, temperature T and time t are selected so as to allow the rare earth element R′ to diffuse along the grain boundaries of the precursor sintered magnets 4, 4′ and increases the concentration of R′ in the grain boundary regions of the R₂Fe₁₄B-based phase. This diffusion of the element R′ is illustrated with the arrows 12.

After the heat treatment, the magnets may be separated from one another due to the second particles of the separating material which is included in the layers 8.

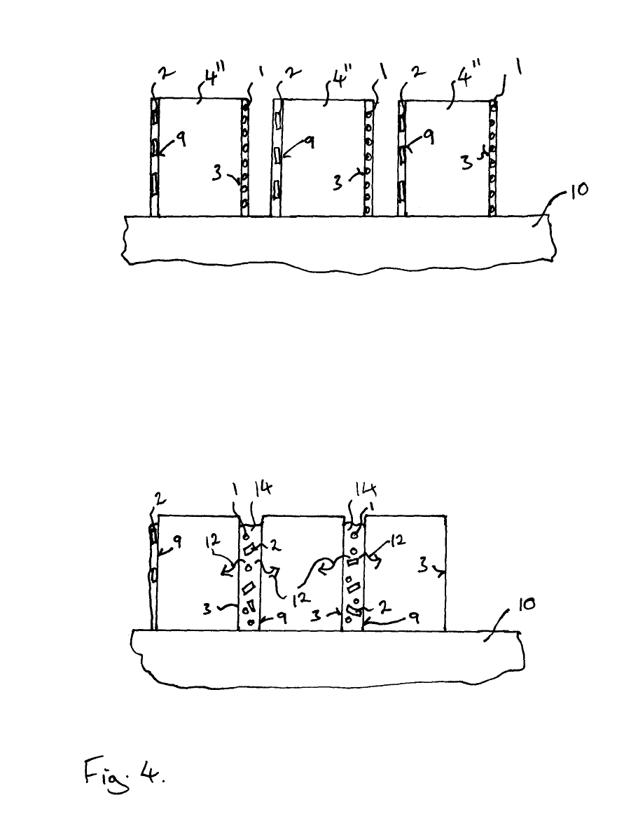

FIG. 4 illustrates a method for producing a R₂Fe₁₄B-type magnet according to a second embodiment. In the second embodiment, the first particles 1 of the rare earth element R′ are arranged on the first surface 3 and the second particles 2 of the further material are arranged on the second surface 9 of the precursor sintered magnet 4″. The second surface 9 is arranged on the opposing side of the precursor sintered magnet 4″ to the first surface 3. A plurality of these precursor sintered magnets 4″ are arranged in a row such that the first particles 1 of the rare earth element R′ face towards second particles 2 of the adjacent precursor sintered magnet 4″ of the row.

The plurality of precursor sintered magnets 4″ may be arranged such that the first particles 1 of the rare earth element R′ are in contact with second particles 2 of the adjacent precursor sintered magnet 4″ of the row during the heat treating. During the heat treating, diffusion of the rare earth element R′ may take place into the two adjacent precursor sintered magnets 4″ as is schematically illustrated by the arrows 12. After heat treatment, a layer 14 is formed between the adjacent magnets which includes the further material and may include remaining parts of the rare earth element R′. Since the further material remains solid and particulate, adjacent magnets of the row can be separated from one another without exerting excessive force which may cause damage to the magnets.

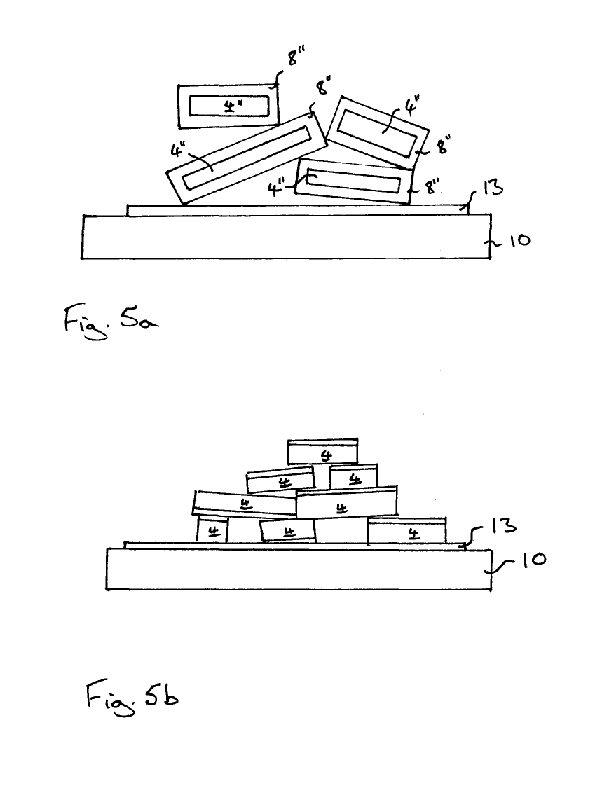

FIG. 5a illustrates a further method for producing a R₂Fe₁₄B-type magnet. In this embodiment, all of the outer surfaces of the precursor sintered magnet 4″ are covered with a layer 8″ comprising first particles of the rare earth element R′ and second particles of the further material.

In this embodiment, the substrate 10 includes a layer 13 comprising second particles of the separating material. The precursor sintered magnets 4″ including layers 8″ comprising first particles of the rare earth element R′ and the second particles of the separating material are placed on this layer 13. The layer 13 acts as a separating means or an adhesion prevention means and prevents the precursor sintered magnets from becoming bonded to the substrate 10 and/or the reaction of the first particles with the substrate 10.

In contrast to the embodiments illustrated in FIGS. 2 to 4, the precursor sintered magnets 4″ are positioned in a heap and have no regular arrangement. This arrangement is suitable for small parts and parts of an irregular shape which cannot easily be stacked in rows or when it would be uneconomic to stack the parts in rows.

FIG. 5b illustrates a further method of arranging the precursor sintered magnets 4, including one or two layers including first particles of the rare earth element R′ and second particles of a separating material. Similar to the embodiment illustrated in FIG. 5a, the substrate 10 includes a layer 13 comprising second particles of the separating material which acts as a separating means or an adhesion prevention means and prevents the precursor sintered magnets from becoming bonded to the substrate 10. The precursor sintered magnets 4 including layers 8 comprising first particles of the rare earth element R′ and the second particles of the separating material are placed on this layer 13. The precursor sintered magnets 4 are positioned in a heap and have no regular arrangement.

The use of the additional layer 13 on the substrate 10 comprising the separating material can also be used in the arrangement of the first embodiment.

The plurality of precursor sintered magnets may also be wrapped in a container comprising a suitable material prior to heat treating. In one embodiment, the plurality of precursor sintered magnets are wrapped in a metal or alloy foil, such as an iron foil, to form an foil container prior to heat treating. The inner surface of the iron foil container may be coated with the further material or with the further material and the rare earth element R′ so that the iron foil does not become bonded to the plurality of magnets as a result of the heat treating.

In the embodiments illustrated in connection with the figures, two or more precursor sintered magnets may be placed in contact with one another. However, diffusion of the rare earth element R′ is not limited to interfaces between precursor sintered magnets that are in direct physical contact. The rare earth element may also diffuse into a precursor sintered magnet or magnets that is or are positioned spaced at a short distance from the rare earth element R′. The rare earth element R′ may move across the space between the particles of the rare earth element R′ and the precursor sintered magnet in the gaseous phase and then diffuse into the precursor sintered magnet, possibly along the grain boundaries of the precursor sintered magnet.

The results obtained from specific examples will now be described.

In a first group of embodiments, the composition of the particles comprising the rare earth element R′ was investigated. Several pastes comprising different rare earth containing compounds were prepared. The composition of the pastes is summarised in table 1.

The first paste comprises dysprosium in the form of dysprosium hydride, the second paste comprises dysprosium in the form of dysprosium oxide and the third paste comprises terbium oxide.

In each case, the paste further comprises fumed silica and 3-methoxy-1-butanol.

The pastes were applied by screenprinting onto one side of a plurality of precursor sintered magnets in amounts to provide 0.6 weight percent dysprosium or terbium, respectively, per piece. The coated precursor magnets were heated at three different temperatures for 6 hours. This heat treatment was carried out in order to allow the dysprosium or terbium to diffuse into the precursor magnets along the grain boundaries and may be described as a grain boundary diffusion heat treatment. Afterwards, an additional heat treatment at 500° C. for 2 hours was performed.

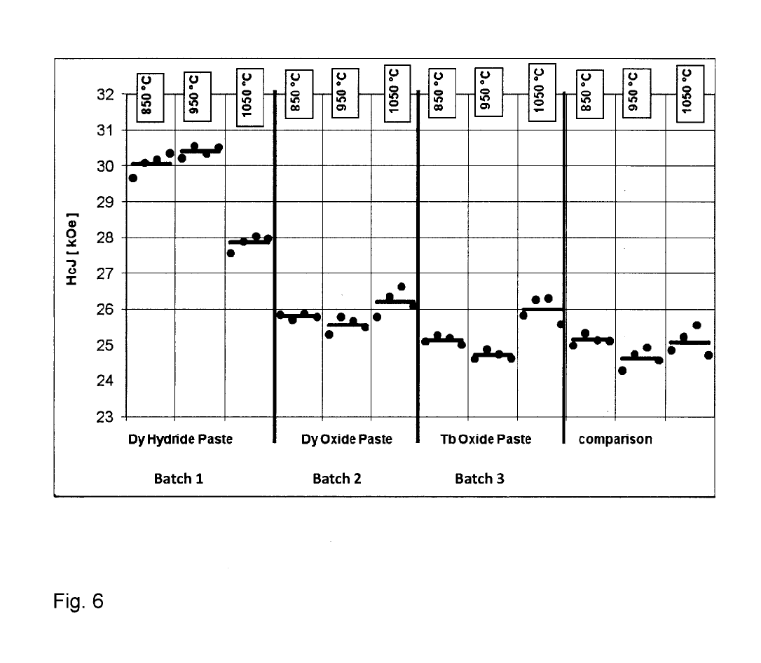

The coercive field strength was measured for the samples and results are summarised in FIG. 6 along with a comparison sample which was given only the heat treatment, but without any grain boundary diffusion.

FIG. 6 illustrates that samples coated with a dysprosium hydride paste have a coercive field strength that is approximately 5 kOe higher than the comparison sample. The highest coercive field strengths were measured after heat treatments at 850° C. and 950° C. The coercive field strength after a heat treatment at 1050° C. was measured to be slightly lower.

The samples coated with dysprosium oxide containing paste or terbium oxide containing paste have an increased coercive field strength compared to the comparison sample. In contrast to the dysprosium hydride containing paste, the increase in coercive field strength was higher after heat treatment at the highest temperature of 1050° C.

The residual field strength of the samples was also measured and was found not to decrease significantly. The dysprosium hydride containing paste, therefore, produces the best increase in coercive field strength.

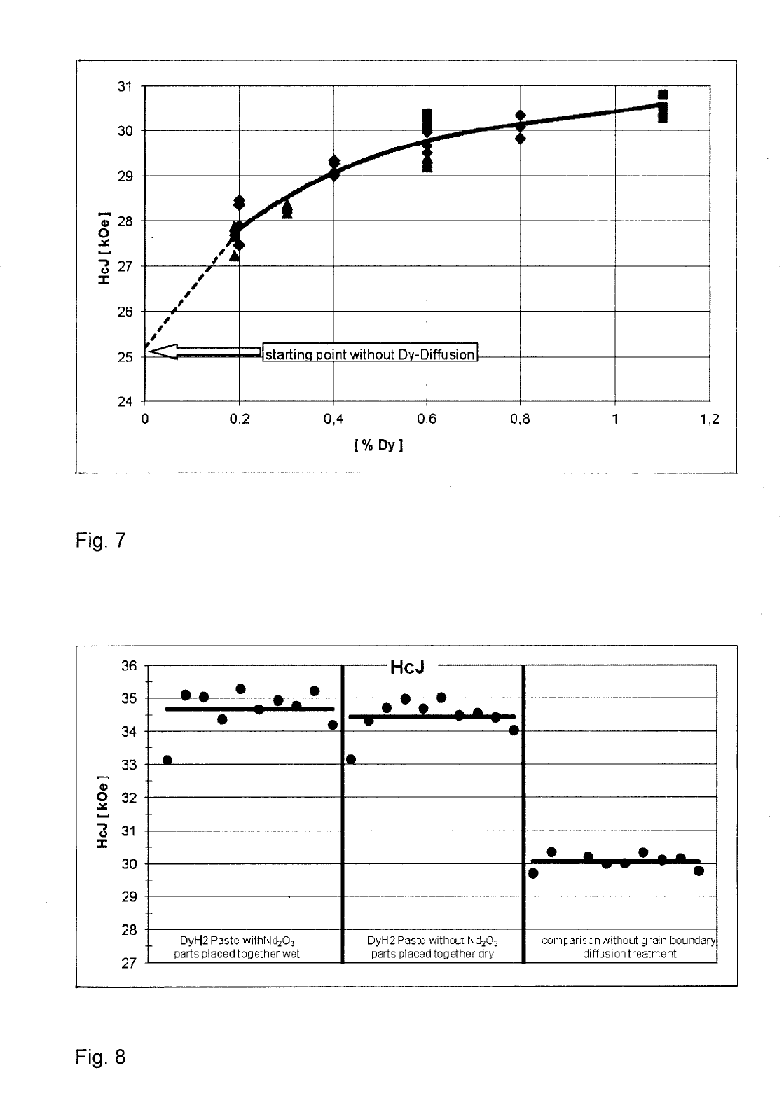

In a further group of embodiments, the effect of the amount of dysprosium hydride on the observed increase in coercive field strength was investigated. The results are summarised in FIG. 7. Samples were coated with between 0.2 and 1.1 weight percent dysprosium hydride and heated for 6 hours at 900° C.

The increase in coercive field strength is greater for amounts of dysprosium hydride in the range of 0.2 to 0.8 weight percent than for samples coated 0.8 to 1.2 weight percent. Therefore, in further examples, 0.6 to 0.8 weight percent dysprosium hydride was applied.

In a further set of embodiments the effect of the separating material was investigated. The results are summarised in table 2. In each example, each R₂Fe₁₄B-type magnet, where R is a mixture of Nd and Dy, has dimensions of 19×10×3.4 mm and a weight of 5 g.

In the first example, 20 precursor R₂Fe₁₄B-type magnets were each coated with 0.04 g of paste comprising dysprosium hydride having the composition given in table 1 so that the weight percent of dysprosium in respect to the weight of the magnets was around 0.8%. The magnets were stacked together without drying and wrapped in iron foil which had been coated with neodymium oxide. The package was heat treated at 950° C. for 6 hours. The pieces were found to be bonded to one another.

In a second example, a further 20 R₂Fe₁₄B-type magnets were each coated with 0.04 g of dysprosium hydride containing paste. The pieces were then dried before stacking and packing in neodymium oxide coated iron foil and being heat treated at 950° C. for 6 hours. Six of the magnets were found to be bonded to one or more further magnets.

In a third example, a paste with 10 weight percent neodymium oxide added to the dysprosium hydride paste. 15 magnets were coated, dried and packed in iron foil coated with neodymium oxide before being heat treated at 950° C. for 6 hours. Two of the magnets were found to have bonded to one another.

In a fourth example, 20 weight percent neodymium oxide was added to the dispersion hydride paste and 0.05 g of this paste was applied to each of 15 R₂Fe₁₄B-type magnets so that around 0.8 weight % dysprosium with respect to the weight of the magnet was added. The magnets were then dried, stacked and packed with iron foil coated with neodymium oxide. The package was heated at 950° C. for 6 hours and, afterwards, none of these magnets were found to be bonded to one another.

In a fifth example, 16 R₂Fe₁₄B-type magnets were coated with 0.05 g of a pastes comprising 20 weight % neodymium oxide but no drying step was carried out before the pieces were stacked and wrapped in neodymium oxide coated iron foil and heat treated at 950° C. for 6 hours. All of the magnets were found to be unbonded after heat treatment.

These results indicate that a proportion of 20 weight percent neodymium oxide is effective as a separation material even without drying of the coated pieces.

The coercive field strength of samples with and without the neodymium oxide additions and comparison samples which were not given the grain boundary diffusion heat treatment were prepared and the coercive field strength was measured. The results are summarised in FIG. 8. These results illustrate that the addition of neodymium oxide in the paste does not affect the increase in the coercive field strength over that measured for untreated samples.

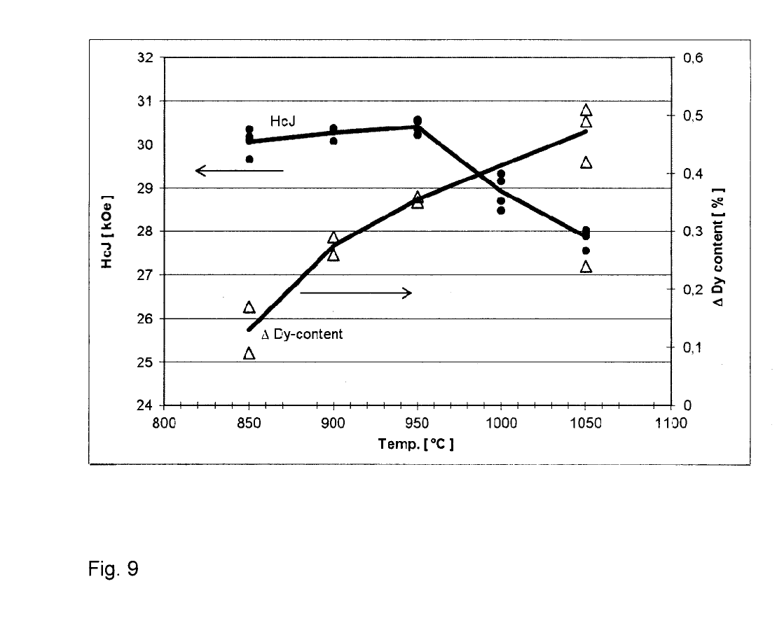

The effect of the temperature at which the grain boundary diffusion process was carried out on the increase in coercive field strength was also investigated. The results are summarised in FIG. 9.

0.6 weight percent dysprosium was applied to the R₂Fe₁₄B-type magnets and the dysprosium content after heat treatment for 6 hours was determined to determine the dysprosium uptake, indicated as delta Dy in FIG. 9. Temperatures within the range of 850° C. to 1050° C. were investigated.

The dysprosium uptake lies in the range of 0.25 and 0.5 weight percent. The amount of dysprosium consumed by the samples generally increases for increasing temperature. As FIG. 9 illustrates, the coercive field strength of the pieces increases slightly between a temperature of 850° C. and 950° C. and then decreases for higher temperatures.

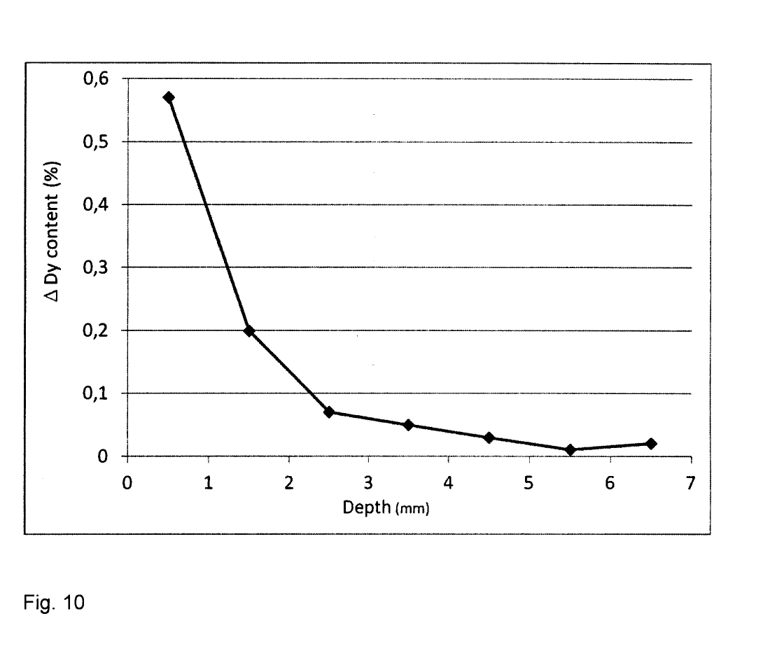

The dysprosium uptake and the change in coercive field strength decrease as a function of depth indicating that the dysprosium content is highest at the outermost surface of the sample as is illustrated by the graph of FIG. 10.

In a further group of embodiments, dysprosium in the form of a mixture of a dysprosium aluminium nickel alloy and a dysprosium copper nickel alloy was investigated. The overall composition is summarised in table 3. This paste was applied to an as-sintered surface of precursor sintered R₂Fe₁₄B-type magnets in an amount to provide 0.6 weight percent dysprosium per piece. The samples were given different heat treatments and the coercive field strength measured at room temperature. The results are summarised in FIG. 11.

FIG. 11 illustrates that for a heat treatment of 900° C. for 6 hours, an increase of around 3.5 kOe in the coercive field strength was achieved. These results are approximately the same as those achieved with the dysprosium hydride containing paste.

The paste may be applied using a brush or with an automatic screen printing device, for example. With the automatic screen printing device, the desired amounts could be applied using a single pass or two passes.

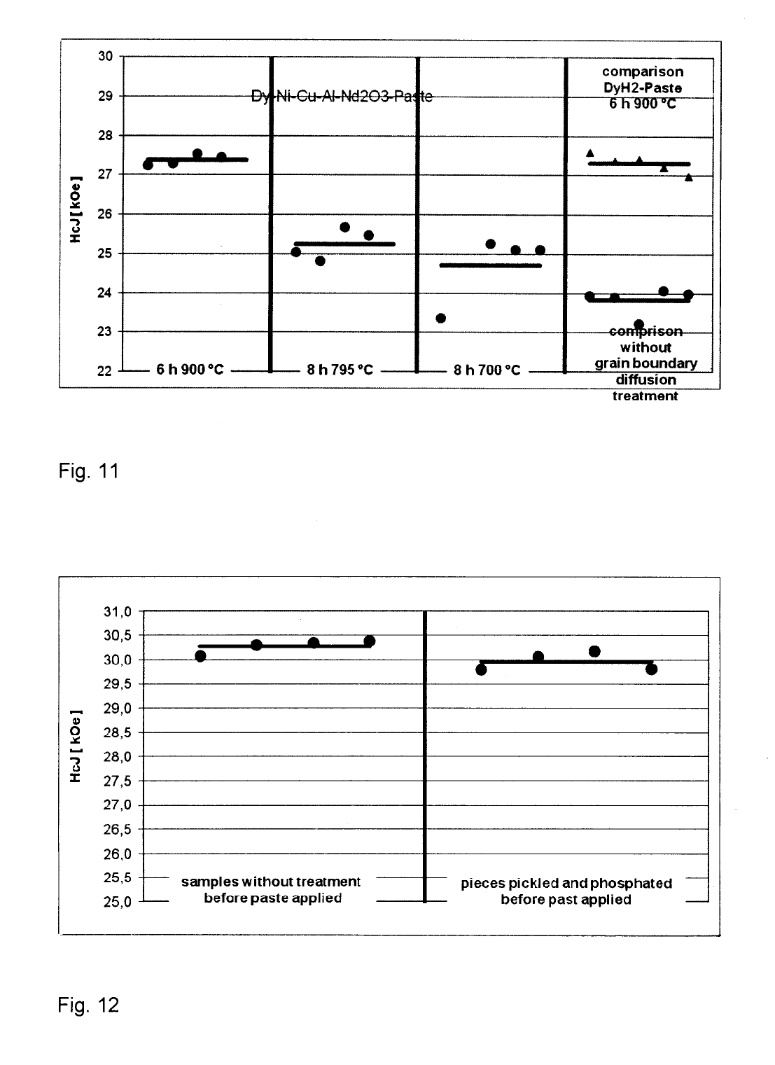

The effect of the surface finish of the precursor sintered magnet on which the dysprosium was applied was investigated. The results are summarised in FIG. 12. In each case 0.6 weight percent dysprosium was applied to the precursor sintered magnets in the form of a dysprosium hydride paste and the coated precursor sintered magnets were heated at 900° C. for 6 hours. Samples for which the precursor magnet was given a pre-treatment of pickling and phosphating and samples for which the dysprosium hydride containing paste was applied directly to the sintered surface have around the same coercive field strength.

In summary, a layer comprising dysprosium hydride particles and 20 weight percent neodymium oxide which is applied to one or more surfaces of sintered R₂Fe₁₄B-type magnets may be used to increase the coercive field strength of the R₂Fe₁₄B-type magnets by subjecting the R₂Fe₁₄B-type magnets to a heat treatment under conditions suitable to allow the dysprosium to diffuse into the body of the R₂Fe₁₄B-type magnets. As in the previous embodiments, R is a mixture of neodymium and dysprosium. At the same time, the neodymium oxide acts as a separation material so that contacting magnets do not bond to one another as a result of the formation of a melt comprising dysprosium hydride during the heat treatment. The packing density of the R₂Fe₁₄B-type magnets during the heat treatment can, therefore, be increased.

1. A method for producing a rare earth-based magnet, comprising:
providing a precursor sintered R₂Fe₁₄B-type magnet,
applying particles comprising a rare earth element R′ to a first surface of the precursor sintered magnet,
applying particles of a further material to the first surface of the precursor sintered magnet and/or a further surface of the precursor sintered magnet,
heat treating the precursor sintered magnet at a temperature T and for a time t selected to allow diffusion of the rare earth element R′ into the precursor sintered magnet and producing a magnet, wherein the further material remains solid and particulate after the heat treating.

2. The method according to claim 1, further comprising
providing a plurality of precursor sintered R₂Fe₁₄B-type magnets,
applying the particles comprising the rare earth element R′ to the first surface of the precursor sintered magnets,
applying the particles of the further material to the first surface of the precursor sintered magnets and/or a further surface of the precursor sintered magnets,
arranging the plurality of precursor sintered magnets such that the particles of the rare earth element R′ and the particles of the further material are positioned between adjacent precursor sintered magnets,
heat treating the plurality of precursor sintered magnets at a temperature T and for a time t selected such that the rare earth element R′ diffuses into the precursor sintered magnets and such that after the heat treating adjacent magnets remain unbonded to one another.

3. The method according to claim 2, wherein
the plurality of precursor sintered magnets are arranged such that a surface of the precursor sintered magnets is in contact with the particles of the rare earth element R′ applied to an adjacent precursor sintered magnet.

4. The method according to claim 2, wherein
the plurality of precursor sintered magnets is arranged in a row such that particles of the rare earth element R′ and particles of the further material are positioned between adjacent precursor sintered magnets of the row,
heat treating the plurality of precursor sintered magnets whilst arranged in the row at a temperature T and for a time t selected such that the rare earth element R′ diffuses into the sintered precursor magnets and such that after the heat treating adjacent magnets of the row remain unbonded to one another.

5. The method according to claim 4, wherein
the particles of the rare earth element R′ and the particles of the further material are applied to the first surface and the plurality of precursor sintered magnets are arranged such that a surface of the precursor sintered magnets is in contact with the particles of the rare earth element R′ applied to an adjacent precursor sintered magnet of the row.

6. The method according to claim 1, further comprising
applying the particles comprising the rare earth element R′ to a second surface of at least one of the precursor sintered magnets, the second surface opposing the first surface, and
applying particles of the further material to the second surface of the at least one precursor sintered magnet.

7. The method according to claim 6, wherein the plurality of precursor sintered magnets is arranged in a row such that the outermost side surfaces of the endmost precursor sintered magnets of the row comprise particles of the rare earth element R′ and particles of the further material.

8. The method according to claim 1, wherein
the particles comprising the rare earth element R′ and the particles of the further material are applied to three or more surfaces of the at least one precursor sintered magnet.

9. The method according to claim 1, wherein
a substrate is provided, the particles of the further material and, optionally, the particles of the rare earth element R′ are placed on the substrate and the precursor sintered magnets are placed on the particles of the further material arranged on the substrate.

10. The method according to claim 1, wherein
the rare earth element R of the precursor sintered magnet is different from the rare earth element R′.

11. The method according to claim 1, wherein
the rare earth element R′ is Dy and/or Tb.

12. The method according to claim 1, wherein
the rare earth element R′ is applied in the form of a hydride or an alloy or a hydrogenated alloy.

13. The method according to claim 1, wherein
0.01 wt % to 2 wt % or 0.1 wt % to 0.6 wt % of the rare earth element R′ is applied to the first surface of the precursor sintered magnet.

14. The method according to claim 1, wherein
a volume ratio of the rare earth element R′ to the further material is between 20 to 1 and 1 to 10.

15. The method according to claim 1, wherein
the precursor sintered magnet has a coercive field strength of H_{c} and the temperature T and the time t are selected such that after the heat treating the magnet has a coercive field strength of at least H_{c}+1 kOe.

16. The method according to claim 1, wherein the temperature T lies within the range of 700° C. to 1100° C. and the time t lies within the range of 0.1 to 100 hours.

17. The method according to claim 1, wherein
the further material is an oxide.

18. The method according to claim 17, wherein
the further material is an oxide of a rare earth element R″ where R″ is different from R and R′.

19. The method according to claim 17, wherein
the further material is an oxide of the rare earth element R.

20. The method according to claim 19, wherein
the further material is Nd₂O₃.

21. The method according to claim 1, wherein
the first surface is an as sintered surface.

22. The method according to claim 1, wherein
the second surface is an as-sintered surface.

23. The method according to claim 1, wherein
the particles of the rare earth element R′ and the particles of the further material are intimately mixed with one another and applied to the first surface and optionally to one or more further surfaces of the precursor sintered magnets in the form of a single layer.

24. The method according to claim 23, wherein
the particles of the rare earth element R′ and the particles of the further material are mixed with at least one liquid or organic substance to form a suspension or a paste and the suspension or the paste is applied to the first surface and optionally to one or more further surfaces of the precursor sintered magnet.

25. The method according to claim 23, wherein
the particles of the rare earth element R′ are mixed with at least one liquid or organic substance to form a first suspension or a first paste and the particles of the further material are mixed with at least one liquid or organic substance to form a second suspension or a second paste and the first suspension or the first paste and the second suspension or the second paste are applied as separate layers to the first surface and optionally to one or more further surfaces of the precursor sintered magnet.

26. The method according to claim 1, wherein
before being heat treated at temperature T, a drying treatment is performed.

27. The method according to claim 1, wherein
one or more metals and/or one or more alloys and/or one or more metal hydrides and/or one or more hydrogenated alloys are applied to the first surface and optionally one or more further surfaces.

28. The method according to claim 1, wherein
Al, and/or Ni and/or copper or their alloys is applied to the first surface and optionally one or more further surfaces.

29. The method according to claim 24, wherein
one or more binders and/or one or more dispersants is added to form the paste.

30. The method according to claim 24, wherein
the paste comprises Nd₂O₃, fumed silica and 3-methoxy-1-butanol.

31. The method according to claim 24, wherein
the paste is applied by painting or screen printing or doctor-blading or gravity or dipping or roller application or spraying.

32. The method according to claim 1, wherein
after the heat treating, the magnets are separable from the adjacent magnets by applying a predetermined force between the adjacent magnets.

33. The method according to claim 1, wherein
after the heat treating the magnet comprises a content of the rare earth element R′ having a distribution that varies from the first surface in directions towards a centre of the magnet.

34. The method according to claim 1, wherein the rare earth element R′ content is highest at the first surface and decreases in directions towards the centre of the magnet.
